(19) United States
(12) Patent Application Publication
(10) Pub. No.: US 2016/0295249 A1
(43) Pub. Date: Oct. 6, 2016

(54) Session Setup Method and Apparatus, and Session Content Delivery Method and Apparatus

(71) Applicant: ZTE CORPORATION, Shenzhen, Guangdong Province (CN)

(72) Inventor: Cheng HUANG, Shenzhen, Guangdong Province (CN)

(73) Assignee: ZTE CORPORATION, Shenzhen, Guangdong Province (CN)

(21) Appl. No.: 15/036,366

(22) PCT Filed: Apr. 21, 2014
(86) PCT No.: PCT/CN2014/075856

§ 371 Date: May 16, 2016

(30) Foreign Application Priority Data
Nov. 14, 2013 (CN) 201310571730.2

(51) Int. Cl. H04N 21/239; G06T 11/20; H04N 21/472; H04N 21/2343; H04L 29/06; H04N 21/643

(52) U.S. Cl. CPC H04N 21/239; H04L 65/1069; H04N 21/64322; H04N 21/472; H04N 21/234363; G06T 11/20

(57) ABSTRACT

Provided are a method and device for establishing content viewing sessions and a method and device for distributing content views. The method for distributing content views includes that: a content viewing session invitation request is received, wherein the content viewing session invitation request carries a spatial configuration of a content viewing session; a spatial distribution for requested content views among different content viewing session terminals is generated according to the spatial configuration of the content viewing session; and content viewing sessions are established with the content viewing session terminals, and content views are distributed to the corresponding content viewing session terminals according to the spatial distribution. By the technical solution, content-views-configuration-information-based content viewing session establishment and content view distribution is implemented.

### TECHNICAL FIELD

The present disclosure relates to the field of communication, and in particular to a method and device for establishing content viewing sessions and a method and device for distributing content views.

### BACKGROUND

As a next-generation social communication medium, a tele-immersion technology establishes a physical scenario in a virtual environment to allow remote collaboration and interaction among geographically distributed users, and is drawing more and more attention of the academic circle and the industrial circle. A well-designed immersive communication system may improve a real environment perception level of a user and greatly improve presence and interactivity of multiple applications from a video conference to a recreational game, namely, bring so-called immersion.

Along with enhancement of a network and increase of a bandwidth, combination of an “immersion technology” and an “Internet television” (Internet Protocol Television (IPTV) and Over The Top (OTT) television) becomes a trend of future development. On one aspect, a user is expected to have more independent choices and obtain a better service experience; and for an operator, personalized content integration, customization and pushing is a key for ensuring the experience of the user, and is also a diversified competition advantage of the operator. Some operating companies have gotten prepared for next-generation high-speed networks, provide multiple cameras to shoot video pictures at different spatial angles, and when bandwidths of the networks are great enough, may simultaneously push the multiple paths of cameras to users to enable the users to simultaneously watch multiple pictures of the same programs at different viewing angles to obtain an immersive viewing experience. Meanwhile, contents of the programs are not limited to undiversified video pictures, and different session modes such as voice chatting and message pushing may be integrated into each aspect of “Internet television” more.

However, nowadays, a user usually owns multiple media playing terminals such as a television, a computer and an intelligent mobile phone at the same time, which have their respective different physical hardware configurations (for example: a size and placement position of a screen) and different media playing capability advantages (for example: suitability for playing a video picture, or suitability for instant message chatting). Therefore, it is necessary to research and provide a method for establishing “Internet television” sessions and content distributing manner consistent with a using habit of the user according to these different terminal capabilities and configurations in combination with a characteristic of a source of session contents of a program.

For the problem of how to perform content viewing session establishment and session content distribution in combination with a characteristic of a source of session contents of a program in a related technology, there is yet no effective solution.

### SUMMARY

The embodiments of the present disclosure provide a method and device for establishing content viewing sessions and a method and device for distributing content views, so as to at least solve the problem of how to perform content viewing session establishment according to a physical characteristic of a content viewing session terminal in combination with a characteristic of a source of content views.

According to one aspect of the embodiments of the present disclosure, a method for distributing content views is provided, which may include that: a content viewing session invitation request is received, wherein the content viewing session invitation request carries a spatial configuration of a content viewing session; a spatial distribution for requested content views among different content viewing session terminals is generated according to the spatial configuration of the content viewing session; and content viewing sessions are established with the content viewing session terminals, and content views are distributed to the corresponding content viewing session terminals according to the spatial distribution.

In an example embodiment, the spatial configuration of the content viewing session may include: a spatial-attribute-based mapping between content views and content viewing session terminals.

In an example embodiment, a spatial attribute may include at least one of: a spatial relationship, including at least one of: top, bottom, left, right and middle; a spatial position, including at least one of: east, west, south and north; and a spatial orientation, including at least one of: facing east, facing west, facing south and facing north.

In an example embodiment, before the step that the spatial distribution for the requested content views among different content viewing session terminals is generated, the method may further include that: a content views request is sent to a content gateway to acquire the requested content views according to content views' identifiers carried in the content viewing session invitation request.

In an example embodiment, the step that the spatial distribution for the requested content views among different content viewing session terminals is generated according to the spatial configuration of the content viewing session may include that: spatial attributes of the content views are checked, and the spatial distribution is generated based on spatial consistency between the spatial attributes of the content views and spatial attributes carried in the spatial configuration of the content viewing session.

In an example embodiment, the step that the content viewing sessions are established with the content viewing session terminals may include that: content viewing session terminals which receive the content views are determined according to the spatial distribution; and a content viewing session invitation request is sent to the determined content viewing session terminals to establish the content viewing sessions with the determined content viewing session terminals.

According to another aspect of the embodiments of the present disclosure, a method for establishing content viewing sessions is provided, which may include that: a first terminal sends a content viewing session invitation request to an application server, wherein the content viewing session invitation request carries a spatial configuration of a content viewing session, and the spatial configuration of the content viewing session may include a spatial-attribute-based mapping between content views and content viewing session terminals.

In an example embodiment, a spatial attribute may include at least one of: a spatial relationship, including at least one of: top, bottom, left, right and middle; a spatial location, including at least one of: east, west, south and north; and a spatial orientation, including at least one of: facing east, facing west, facing south and facing north.

In an example embodiment, the method may further include that: the first terminal establishes a content viewing session with the application server; and the first terminal receives a first content view, which is distributed from the application server according to the spatial configuration of the content viewing session, corresponding to the first terminal.

In an example embodiment, the method may further include that: at least one second terminal in the content viewing session terminals receives a content viewing session request sent by the application server according to the spatial configuration of the content viewing session, and establishes a content viewing session with the application server; and the at least one second terminal receives a second content view, which is distributed from the application server according to the spatial configuration of the content viewing session, corresponding to the at least one second terminal.

According to another aspect of the embodiments of the present disclosure, a device for distributing content views is provided, which may be located in an application server and include: a receiving component, configured to receive a content viewing session invitation request, wherein the content viewing session invitation request carries a spatial configuration of a content viewing session; a generation component, configured to generate a spatial distribution for requested content views among different content viewing session terminals according to the spatial configuration of the content viewing session; an establishment component, configured to establish content viewing sessions with the content viewing session terminals; and a distributing component, configured to distribute content views to the corresponding content viewing session terminals according to the spatial distribution.

In an example embodiment, the spatial configuration of the content viewing session may include: a spatial-attribute-based mapping between content views and content viewing session terminals.

In an example embodiment, a spatial attribute may include at least one of: a spatial relationship, including at least one of: top, bottom, left, right and middle; a spatial location, including at least one of: east, west, south and north; and a spatial orientation, including at least one of: facing east, facing west, facing south and facing north.

In an example embodiment, the device may further include: an acquisition component, configured to send a content views request to a content gateway to acquire the requested content views according to content views' identifiers carried in the content viewing session invitation request.

In an example embodiment, the generation component may be configured to check spatial attributes of the content views, and generate the spatial distribution based on spatial consistency between the spatial attributes of the content views and spatial attributes carried in the spatial configuration of the content viewing session.

In an example embodiment, the establishment component may be configured to determine, according to the spatial distribution, content viewing session terminals which receive the content views, and send a content viewing session invitation request to the determined content viewing session terminals to establish the content viewing sessions with the determined content viewing session terminals.

According to another aspect of the embodiments of the present disclosure, a device for establishing content viewing sessions is provided, which may be located in a first terminal and include: a sending component, configured to send a content viewing session invitation request to an application server, wherein the content viewing session invitation request carries a spatial configuration of a content viewing session, and the spatial configuration of the content viewing session may include a spatial-attribute-based mapping between content views and content viewing session terminals.

In an example embodiment, a spatial attribute may include at least one of: a spatial relationship, including at least one of: top, bottom, left, right and middle; a spatial location, including at least one of: east, west, south and north; and a spatial orientation, including at least one of: facing east, facing west, facing south and facing north.

In an example embodiment, the device may further include: an establishment component, configured to establish a content viewing session with the application server; and a receiving component, configured to receive a first content view, which is distributed from the application server according to the spatial configuration of the content viewing session, corresponding to the first terminal.

According to the embodiments of the present disclosure, the content viewing session invitation request carries the spatial configuration of the content viewing session, so that the content views may be requested at least according to the spatial configuration, or the content views may be distributed at least according to the spatial configuration.

### BRIEF DESCRIPTION OF THE DRAWINGS

The drawings described here are adopted to provide further understanding of the present disclosure, and form a part of the present disclosure. Schematic embodiments of the present disclosure and description thereof are adopted to explain the present disclosure and not intended to form improper limits to the present disclosure. In the drawings:

FIG. 1 is a first flowchart of a method for distributing content views according to an embodiment of the present disclosure;

FIG. 2 is a first flowchart of a method for receiving content views according to an embodiment of the present disclosure;

FIG. 3 is a diagram of a session application system according to scenario 1 of an embodiment of the present disclosure;

FIG. 4 is a flowchart of a method for distributing content views according to scenario 1 of an embodiment of the present disclosure;

FIG. 5 is a first structure block diagram of a device for distributing content views according to an embodiment of the present disclosure;

FIG. 6 is a first structure block diagram of a device for receiving content views according to an embodiment of the present disclosure;

FIG. 7 is a second flowchart of a method for distributing content views according to an embodiment of the present disclosure;

FIG. 8 is a second flowchart of a method for receiving session contents according to an embodiment of the present disclosure;

FIG. 9 is a diagram of a session application system according to scenario 2 of an embodiment of the present disclosure;

FIG. 10 is a flowchart of a method for distributing content views according to scenario 2 of an embodiment of the present disclosure;

FIG. 11 is a second structure block diagram of a device for distributing content views according to an embodiment of the present disclosure; and

FIG. 12 is a second structure block diagram of a device for receiving session contents according to an embodiment of the present disclosure.

### DETAILED DESCRIPTION OF THE EMBODIMENTS

It is important to note that embodiments in the present disclosure and characteristics in the embodiments may be combined under the condition of no conflicts. The present disclosure will be described below with reference to the drawings and the embodiments in detail.

The embodiments of the present disclosure provide a solution to establishment of a content viewing session and distributing of session contents according to session content configuration information, so as to at least implement session content configuration information-based session establishment and session content distributing. The “session content configuration information” refers to configuration information which is set in combination with a characteristic (spatial attribute, session mode capability and the like) of a session content source on the basis of a physical characteristic (spatial attribute, session mode capability and the like) of a content viewing session terminal and configured to control a distribution of a session content among different content viewing session terminals. The session content configuration information includes, but not limited to, a spatial configuration of a content viewing session and a mode configuration of a content viewing session.

Therefore, the embodiment of the present disclosure provides a spatial attribute and session mode attribute-based method for distributing session contents and a corresponding method for receiving session contents. As one aspect of the embodiments of the present disclosure, the embodiments of the present disclosure also illustrate a method and device for establishing sessions. Two scenarios of the embodiment of the present disclosure will be described below respectively.

Scenario 1: Spatial-Attribute-Based Session Content Configuration

In scenario 1 of the embodiments of the present disclosure, a content viewing session invitation request carries a spatial configuration of a content viewing session, and content views are distributed to corresponding content viewing session terminals based on spatial consistency between spatial attributes of the requested content views and spatial attributes carried in the spatial configuration of the content viewing session, wherein consistency between the spatial attributes refers to that the content viewing session terminal and the content view have the same spatial attribute. A method for distributing content views of the embodiment of the present disclosure will be described below in detail.

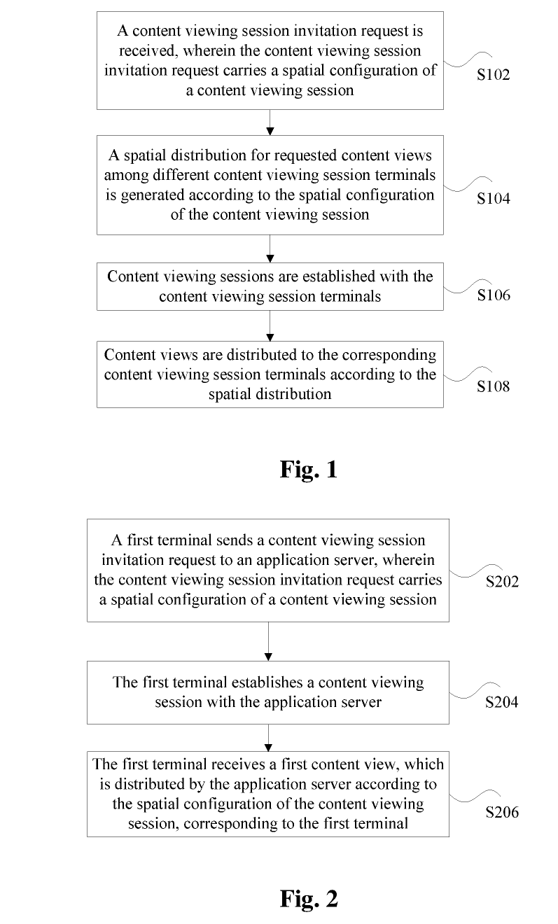

The embodiment of the present disclosure provides a method for distributing content views. FIG. 1 is a first flowchart of a method for distributing content views according to an embodiment of the present disclosure, and as shown in FIG. 1, the method includes the following steps (Step S102 to Step S108).

Step S102: a content viewing session invitation request is received, wherein the content viewing session invitation request carries a spatial configuration of a content viewing session.

In this embodiment, the spatial configuration of the content viewing session records spatial attributes of various content viewing session terminals in the content viewing session invitation request, and the spatial attributes may be spatial attributes of the content views supported (or received) by each content viewing session terminal, and may also be a spatial attribute specified by the user for a content viewing session terminal supporting multiple spatial attributes. In the embodiment of the present disclosure, the spatial configuration of the content viewing session may include, but not limited to: a spatial-attribute-based-mapping between the content viewing session terminals and the content views. The spatial-attribute-based-mapping records the spatial attributes of the content views supported (or received) by each content viewing session terminal, i.e. a mapping between the content viewing session terminals and the content views. In the embodiment of the present disclosure, the spatial attribute may include, but not limited to, at least one of:

a spatial relationship, i.e. a mapping between the content viewing session terminals and the content views in terms of spatial relationship, including at least one of: top, bottom, left, right and middle;

a spatial location, i.e. a mapping between the content viewing session terminals and the content views in terms of spatial location, including at least one of: east, west, south and north; and

a spatial orientation, i.e. a mapping between the content viewing session terminals and the content views in terms of spatial orientation, including at least one of: facing east, facing west, facing south and facing north.

In an exemplary implementation mode of the embodiments of the present disclosure, the spatial configuration of the content viewing session carried in the content viewing session invitation request may be an information list including identifiers of the content viewing session terminals, and the list records the spatial attributes of the content views supported (or received) by each content viewing session terminal. For example, a first content viewing session terminal is configured to receive a content view with a spatial attribute “left”, a second content viewing session terminal is configured to receive a content view with a spatial attribute “right”, and so on.

It is important to note that multiple forms may be adopted for carrying the spatial configuration of the content viewing session in the content viewing session invitation request in consideration of different implementation protocols in a specific implementation process, and there are no limits made in the embodiment of the present disclosure.

In addition, a method for acquiring the spatial attributes of various content viewing session terminals and a method for defining spatial attribute metadata of the content views are not in the range of discussion of the embodiment of the present disclosure, and may be implemented by multiple methods according to the related technology. Therefore, the embodiment of the present disclosure makes descriptions only with an example. As an example of the embodiment of the present disclosure, configuration interfaces may be provided in the content viewing session terminals to configure a content viewing session terminal list, the content viewing session terminals involved in the spatial configuration of the content viewing session may be multiple content viewing session terminals of one user, and may also be, of course, content viewing session terminals of different users as long as their information is associated, and there are no limits made in the embodiment of the present disclosure.

Step S104: a spatial distribution for requested content views among different content viewing session terminals is generated according to the spatial configuration of the content viewing session.

In the embodiment of the present disclosure, the spatial distribution of the content views requested by the content viewing session invitation request among different content viewing session terminals may be generated according to the spatial configuration of the content viewing session carried in the content viewing session invitation request, wherein the spatial distribution refers to a corresponding relationship between content views and content viewing session terminals. In an example embodiment, when the spatial distribution is generated, spatial attributes of the content views may be checked, and the spatial distribution is generated based on spatial consistency between the spatial attributes of the content views and the spatial attributes carried in the spatial configuration of the content viewing session. Consistency refers to a matching relationship between the spatial attributes of the content views and the spatial attributes carried in the spatial configuration of the content viewing session.

In an example embodiment, checking consistency may match the spatial attributes of the content views and the spatial attributes of the content viewing session terminals and associate the corresponding content views and content viewing session terminals according to the spatial attributes of the content views to obtain the mapping relationship between the content viewing session terminals and content views.

For example, the spatial configuration of the content viewing session includes a spatial attribute “left” of content viewing session terminal 1 and a spatial attribute “right” of content viewing session terminal 2, the spatial attributes of the requested content views include “top”, “bottom”, “left” and “right”, and then the generated spatial distribution indicates that content viewing session terminal 1 corresponds to the session content with the spatial attribute “left” and content viewing session terminal 2 corresponds to the session content with the spatial attribute “right”.

Of course, the example is only an exemplary description about the embodiment of the present disclosure, and in the embodiment of the present disclosure, the content viewing session terminals may also support multiple spatial attributes. For example, the content viewing session terminals may support the content views with the spatial attributes top, middle and bottom, and spatial distribution generation methods are substantially the same, and will not be elaborated in the embodiment of the present disclosure.

In the embodiment of the present disclosure, the content views and their spatial attribute metadata may be locally stored, and may also be stored in another server, so that a content views request may also be sent to a content gateway to acquire the requested content views according to content views' identifiers carried in the content viewing session invitation request if the content views and their spatial attributes are not locally stored. After the content views are acquired, the spatial distribution is generated by the abovementioned method according to the spatial attributes of the content views.

Of course, the content views may also be locally stored according to a requirement, and there are no limits made in the embodiment of the present disclosure.

Step S106: content viewing sessions are established with the content viewing session terminals.

In the embodiment of the present disclosure, the content viewing sessions may be established with the content viewing session terminals according to the generated spatial distribution of the content views, namely whether to establish the content viewing sessions with the content viewing session terminals or not is determined by judging whether there are content views with spatial attributes consistent with those of the content viewing session terminals.

In an example embodiment, the content viewing sessions may be directly established with each content viewing session terminal under the condition that the spatial attributes of the content viewing session terminals in the spatial configuration of the content viewing session are completely matched with the spatial attributes of the requested content views. As an example of the condition, the content viewing session terminal initiating the content viewing session invitation request may have known the spatial attributes of the requested content views before sending the request, so that the content viewing session terminals corresponding to the content views and their spatial attributes may be contained in the content viewing session invitation request for sending.

For example, the content viewing session terminal knows that the requested content views include three parts of content views with the spatial attributes “top”, “middle” and “bottom” before initiating the content viewing session invitation request, and the spatial configuration of the content viewing session may be configured to include three content viewing session terminals which correspond to the content views and have the spatial attributes “top”, “middle” and “bottom” respectively.

In addition, under the condition that the spatial attributes of the content viewing session terminals in the spatial configuration of the content viewing session and the spatial attributes of the requested content views are unmatched but intersected, content viewing session terminals required to establish content viewing sessions may be determined according to the spatial distribution at first, and then the content viewing sessions with the determined content viewing session terminals may be established. As an example of the condition, the spatial attributes of the requested content views may not be known when the request is initiated, and multiple content viewing session terminals and their spatial attributes are sent.

Of course, when the content viewing session is established, the content viewing session terminals may be determined according to the generated spatial distribution, and the content viewing session terminals required to establish the content viewing sessions may also be determined based on spatial consistency between the spatial attributes of the spatial configuration of the content viewing session and the spatial attributes of the content views.

Step S108: content views are distributed to the corresponding content viewing session terminals according to the spatial distribution.

In the embodiment of the present disclosure, the spatial distribution describes the content viewing session terminals corresponding to the spatial attributes of the content views, and the content views may be sent to the corresponding content viewing session terminals according to the spatial distribution respectively. The corresponding content views refer to content views of which spatial attributes are consistent with the spatial attributes of the content viewing session terminals.

It is important to note that there are no limits to a sequence of the steps in the embodiment of the present disclosure although each step is marked in a numbering form in the embodiment of the present disclosure, and the execution sequence of the steps of the embodiment of the present disclosure may be regulated. For example, Step S104 and Step S106 may be exchanged.

By the method of the embodiment of the present disclosure, the content views may be distributed according to the spatial attributes of the content views and the spatial configuration of the content viewing session.

The embodiment of the present disclosure further provides a method for receiving content views. FIG. 2 is a first flowchart of a method for receiving content views according to an embodiment of the present disclosure, and as shown in FIG. 2, the method includes the following steps.

Step S202: a first terminal sends a content viewing session invitation request to an application server, wherein the content viewing session invitation request carries a spatial configuration of a content viewing session, and the spatial configuration of the content viewing session includes a spatial-attribute-based mapping between content views and content viewing session terminals.

By Step S202, the spatial configuration of the content viewing session may be sent to the application server, and then the application server may perform content views distributing according to the spatial configuration of the content viewing session.

In the embodiment of the present disclosure, if there is no content view corresponding to the first terminal, a content viewing session between the first terminal and the application server may not be established, and subsequent steps are not required. It is important to note that a content viewing session invitation request sending method is also an independent solution of the embodiment of the present disclosure.

After the content viewing session invitation request is sent, Step S204 and Step S206 may also be executed. It is important to note that the content viewing session between the first terminal and the application server may also be established when there is no content view corresponding to the first terminal, and there are no limits made in the present disclosure.

Step S204: the first terminal establishes a content viewing session with the application server.

Step S206: the first terminal receives a first content view, which is distributed from the application server according to the spatial configuration of the content viewing session, corresponding to the first terminal.

The method for receiving content views of the embodiment of the present disclosure corresponds to the abovementioned method for distributing content views, and the same or similar parts will not be elaborated in the embodiment of the present disclosure.

In an example embodiment, at least one second terminal in the content viewing session terminals receives a content viewing session request sent by the application server according to the spatial configuration of the content viewing session, and establishes a content viewing session with the application server. The at least one second terminal receives a second content view, which is distributed from the application server according to the spatial configuration of the content viewing session, corresponding to the at least one second terminal.

In order to make the technical solutions and implementation methods of the present disclosure clearer, an implementation process will be described below with reference to an exemplary embodiment in detail.

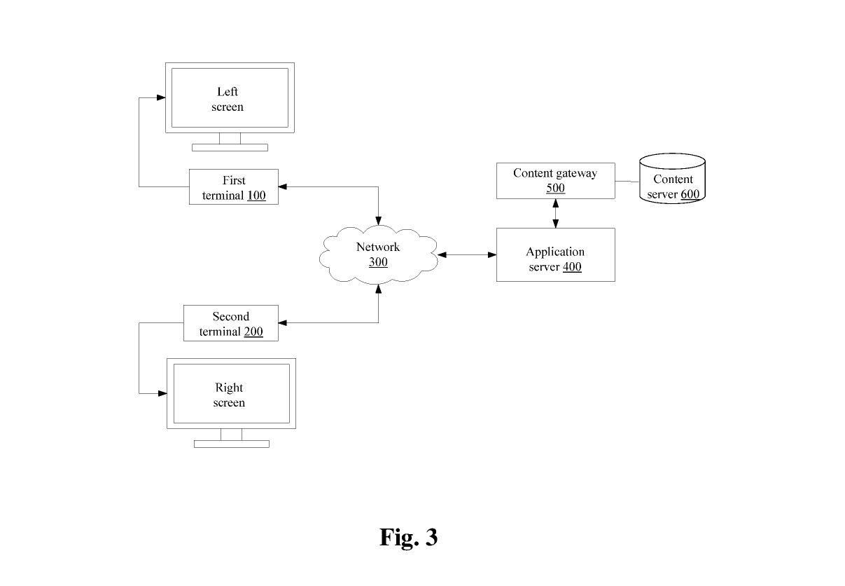

In the exemplary embodiment of the present disclosure, the application server receives a content viewing session invitation request sent by a content viewing session terminal, and content views are acquired according to a spatial configuration of a content viewing session carried in the content viewing session invitation request, and are distributed to corresponding content viewing session terminals. In the exemplary embodiment of the present disclosure, exemplary descriptions are made with a system shown in FIG. 3 as an example.

As shown in FIG. 3, the session system of the exemplary embodiment of the present disclosure at least includes a first terminal 100, a second terminal 200, a communication network 300, an application server 400, a content gateway 500 and a content server, wherein

the first terminal 100 and the second terminal 200 are responsible for sending content viewing session invitation requests according to session content selection of users to receive multimedia session contents such as an IPTV program and an OTT application, performing signal processing on the received contents for decoding and sending the processed contents to screens for playing. The first terminal 100 and the second terminal 200 may usually be mobile and fixed communication terminals such as intelligent mobile phones, tablets and set-top boxes, wherein left screens and right screens may also be television display screens, tablet screens or the like.

The first terminal 100 and the second terminal 200 are required to establish communication connections with the application server 400 on the basis of the communication network 300 to access service provided by a service provider and a content provider, and the communication connections are usually established through the communication network 300 such as a Global System for Mobile Communications (GSM), a Universal Mobile Telecommunication System (UMTS), a Worldwide Interoperability for Microwave Access (WIMAX) network, a Long Term Evolution (LTE) network and the like.

The application server 400 is responsible for providing a network side session service implementation capability, including: receiving and processing a content viewing session invitation request and a content viewing session re-invitation request of a user terminal, establishing a content view distributing channel with the user terminal, implementing session state maintenance and lifecycle management, acquiring, storing and managing a content view and distributing the content view to the user terminal through the established content view distributing channel; and in addition, the application server 400 is further responsible for processing a registration request of the user terminal, and ensuring integrity and privacy of data and user privacy.

The content gateway 500 is responsible for providing a content access interface of the content server 600 for the application server 400, including: establishing a content session with the content server 600 to acquire requested content views according to a request of the application server 400.

The content server 600 is responsible for providing a network side content storage capability, including: storing content views and content views' metadata.

In the exemplary embodiment, a user has multiple content viewing session terminals, and by virtue of a first terminal, the user selects content views and a spatial configuration of a content viewing session, and sends a content viewing session invitation request. One or more other terminals, called one or more second terminals, are involved in the spatial configuration of the content viewing session.

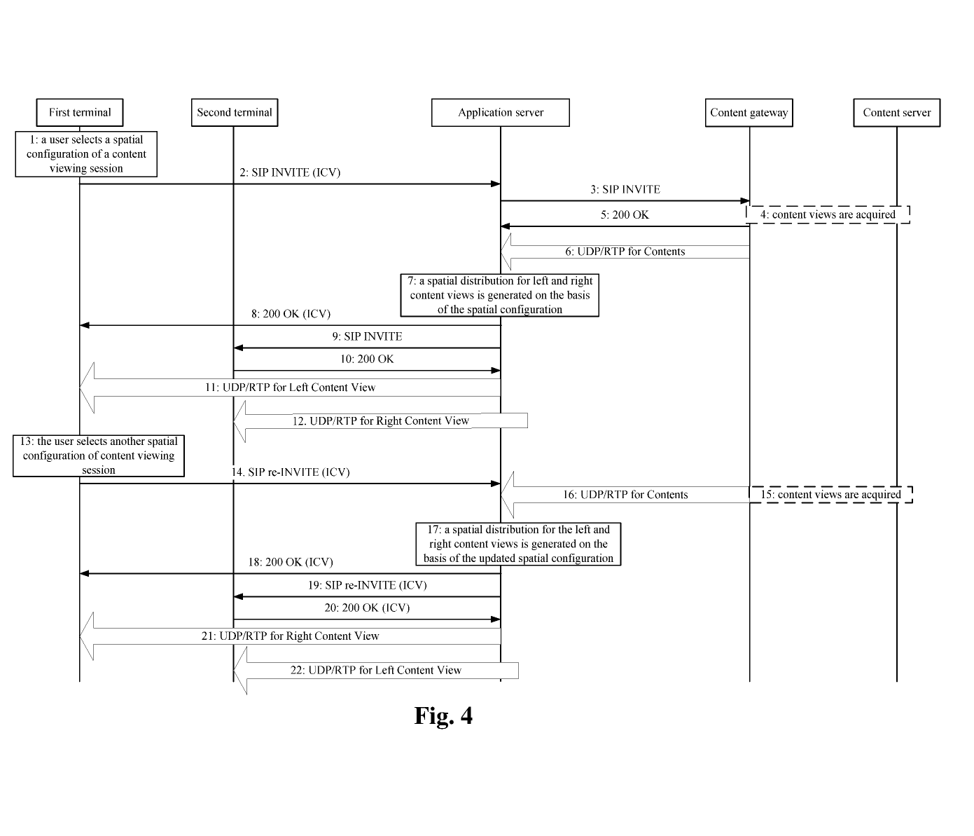

A method of the embodiment includes the following steps (Step S402 to Step S444), and as shown in FIG. 4, FIG. 4, serving as a diagram of interaction between equipment only, shows a basic signalling interaction flow. Each step of the embodiment of the present disclosure will be described below with reference to FIG. 4 in detail.

Step S402 (corresponding to “1” in FIG. 4): the user browses selectable session contents on the first terminal, for example: an IPTV program (on demand or live), an Internet video clip and an OTT Internet multimedia application, which may be implemented by virtue of a content recommendation function or content searching function provided by a service provider in an existing service environment; and after content views expected to be received are selected, the user may set the content views, namely create session content configuration information.

In the exemplary embodiment, it is supposed that content views capable of representing an immersive panoramic view are selected by the user and may include multiple content views (for example: left view and right view) which are different but related. In order to better receive and process the content views, the session content configuration information is a spatial configuration of a content viewing session, namely the user may select a spatial configuration solution for content view receiving and playing of a content viewing session terminal on the basis of spatial attributes, including, but not limited to: 1) a spatial-relationship-based spatial configuration of the content viewing session, referring to that a content viewing session terminal with a specific spatial relationship receives and plays a corresponding content view, including: “top”, “bottom”, left”, “right” and “middle”; 2) a spatial-position-based spatial configuration of the content viewing session, referring to that a content viewing session terminal at a specific spatial location receives and plays a corresponding content view, including: “east”, west”, “south” and “north”; and 3) a spatial-orientation-based spatial configuration of the content viewing session, referring to that a content viewing session terminal with a specific spatial orientation receives and plays a corresponding content view, including: “facing east”, “facing west”, “facing south” and “facing north”.

In the exemplary embodiment, the spatial configuration selected by the user is that a first content view (left view) is distributed to the first terminal and a second content view (right view) is distributed to a second terminal.

Step S404 (corresponding to “2” in FIG. 4): the first terminal sends a content viewing session invitation request to the application server according to the choices of the user, wherein the request carries the session content configuration information which is the spatial configuration of the content viewing session and used for setting a corresponding relationship between content viewing session terminals and content views on the basis of spatial attributes.

In the exemplary embodiment, the content viewing session invitation request is a Session Initiation Protocol (SIP) INVITE message, a header of the message carrying content views' identifiers, for example:

INVITE sip: tv-video-c10616@example.com SIP/2.0
Via: SIP/2.0/TCP tv.example.com
;branch=z9hG4bKhjhs8ass83

The spatial configuration of the content viewing session in a body of the message, as shown below, includes: a content viewing session terminal Uniform Resource Identifier (URI) list and a parameter of a spatial configuration of a content viewing session.

```
    Content-Type: application/resource-lists+xml
    Content-Disposition: recipient-list
    <?xml version=“1.0” encoding=“UTF-8”?>
    <resource-lists xmlns=“urn:ietf:params:xml:ns:resource-lists”
    xmlns:isc=“urn:xxx:params:xml:ns:sessionControl”>
    <list>
    <entry uri= isc:spatialConfiguration=“enabled” isc:location=“left”/>
    <entry uri=sip:alice 2@example.com
    isc:spatialConfiguration=“enabled”
isc:location=“right”/>
    </list>
    </resource-lists>
```

In this embodiment, sip:alice 1@example.com and sip:alice 2@example.com represent a SIP URI of a first terminal of the user and a SIP URI of a second terminal respectively; isc:spatialConfiguration=“enabled” represents that the session content configuration information is the spatial configuration of the content viewing session; and isc:location=“left” and isc:location=“right” correspond to the spatial attributes in the spatial configuration, and represent that the first terminal supports (is about to receive) the first content view (left view) and the second terminal supports (is about to receive) the second content view (right view) respectively.

Step S406 (corresponding to “3” in FIG. 4): the application server receives the content viewing session invitation request, and checks whether the corresponding content views are locally cached or not according to the content views' identifiers in the request, and if NO, the application server sends a content views request (corresponding to SIP INVITE in FIG. 4) to the content gateway.

In the exemplary embodiment, the application server sends the content views request through the SIP INVITE message. Without loss of generality, the application server may send the SIP INVITE message once to request the content gateway for all the content views, and may also send the SIP INVITE message for many times to request the content gateway for all the content views from different sources or for different parts (for example, left and right views) of the content views.

Step S408 (corresponding to “4” in FIG. 4): the content gateway establishes a session with the content server to acquire the practical content views. A method for establishing sessions and a practically adopted content view distributing technology are determined according to specific implementation of an external interface of the content server.

Step S410 (corresponding to “5” in FIG. 4): the content gateway returns a 200 OK response to the application server, and establishes a content view distributing channel with the application server.

Step S412 (corresponding to “6” in FIG. 4): the content gateway distributes the content views to the application server. In the embodiment, the content views are video streams corresponding to the left and right content views, and the content gateway distributes the content views, i.e. the video streams, to the application server through the established User Datagram Protocol/Real-time Transport Protocol (UDP/RTP) media channel.

Step S414 (corresponding to “7” in FIG. 4): the application server checks spatial attributes of the acquired content views, and generates a spatial distribution for the content views among different content viewing session terminals based on spatial consistency between the spatial attributes of the content views and the spatial attributes carried in the spatial configuration of the content viewing session in the content viewing session invitation request. In the embodiment, the spatial distribution generated by the application server indicates that the first content view (left view) is distributed to the first terminal and the second content view (right view) is distributed to the second terminal.

Step S416 (corresponding to “8” in FIG. 4): the application server returns a 200 OK response to the first terminal, and establishes a first content view (left view) distributing channel with the first terminal.

Step S418˜Step S420: the application server initiates a content viewing session invitation request to the second terminal (equivalent to “9” in FIG. 4: a SIP INVITE message is sent to the second terminal) according to the SIP URI of the second terminal in the content viewing session terminal list, and establishes a second content view (right view) distributing channel with the second terminal (equivalent to “10” in FIG. 4: the application server returns a 200 OK message to the second terminal, and establishes a distributing channel between the application server and the second terminal).

Step S422˜Step S424: through the established UDP/RTP media channels, the application server distributes the first content view (left view) to the first terminal (equivalent to “11” in FIG. 4: the first content view is sent through the UDP/RTP media channel), and distributes the second content view (right view) to the second terminal (equivalent to “12” in FIG. 4: the second content view is sent through the UDP/RTP media channel).

There exists another situation for Step S418˜Step S420, and the application server checks the spatial attributes of the acquired content views, and judges whether there is the second content view (right view) corresponding to the second terminal in the acquired content views or not according to the spatial configuration of the content viewing session in the content viewing session invitation request. If YES, the application server sends a content viewing session request to the second terminal, and establishes the second content view (right view) distributing channel with the second terminal.

Step S426 (corresponding to “13” in FIG. 4): in the embodiment, the user selects to modify the spatial configuration of the content viewing session to indicate that the first content view (left view) is distributed to the second terminal and the second content view (right view) is distributed to the first terminal according to a requirement.

Step S428 (corresponding to “14” in FIG. 4): the first terminal sends a content viewing session re-invitation request (equivalent to SIP re-INVITE message in FIG. 4) to the application server, wherein the request carries session content configuration information which is a spatial configuration of a content viewing session and used for setting a corresponding relationship between content viewing session terminals and content views on the basis of spatial attributes.

In the exemplary embodiment, the content viewing session re-invitation request is a SIP re-INVITE message, and similar to Step S404, a header of the message carries content views' identifiers, and a body of the message carries the spatial configuration of the content viewing session, including: a content viewing session terminal URI list and parameters of a spatial configuration of a content viewing session.

```
    Content-Type: application/resource-lists+xml
    Content-Disposition: recipient-list
    <?xml version=“1.0” encoding=“UTF-8”?>
    <resource-lists xmlns=“urn:ietf:params:xml:ns:resource-lists”
    xmlns:isc=“urn:xxx:params:xml:ns:sessionControl”>
    <list>
    <entry uri= isc:spatialConfiguration=“enabled” isc:location=“right”/>
    <entry uri=sip:alice 2@example.com
    isc:spatialConfiguration=“enabled”
isc:location=“left”/>
    </list>
    </resource-lists>
```

In this embodiment, sip:alice 1@example.com and sip:alice 2@example.com represent a SIP URI of a first terminal of the user and a SIP URI of a second terminal respectively; isc:spatialConfiguration=“enabled” represents that the session content configuration information is the spatial configuration of the content viewing session; and isc:location=“right” and isc:location=“left” correspond to the spatial attributes in the spatial configuration, and represent that the first terminal is about to receive the second content view (right view) and the second terminal is about to receive the first content view (left view) respectively.

Step S430˜Step S432: the content gateway distributes the content views, i.e. the video streams, acquired from the content server to the application server through the established UDP/RTP media channels (corresponding to “15” in FIG. 4: the content gateway requests the content server for the content views, and “16” in FIG. 4: the content gateway distributes the content views to the application server through the UDP/RTP media channels).

Step S434 (corresponding to “17” in FIG. 4): the application server checks the spatial attributes of the acquired content views, and generates the spatial distribution for the content views among different content viewing session terminals based on spatial consistency between the spatial attributes of the content views and the spatial attributes carried in the spatial configuration of the content viewing session in the content viewing session re-invitation request. In the embodiment, the spatial distribution generated by the application server indicates that the second content view (right view) is distributed to the first terminal and the first content view (left view) is distributed to the second terminal.

Step S436 (corresponding to “18” in FIG. 4): the application server returns a 200 OK response to the first terminal, and updates an existing content viewing session with the first terminal into the second content view (right view) distributing channel.

Step S438˜Step S440: the application server initiates a content viewing session invitation request to the second terminal, and updates an existing content viewing session with the second terminal into the first content view (left view) distributing channel (corresponding to “19” in FIG. 4 of sending the SIP re-INVITE message and “20” of returning a 200 OK message).

Step S442˜Step S444: through the established UDP/RTP media channels, the application server distributes the second content view (right view) to the first terminal (corresponding to “21” in FIG. 4), and distributes the first content view (left view) to the second terminal (corresponding to “22” in FIG. 4).

It is important to note that the steps shown in the flowchart of the drawing may be executed in a computer system, such as a group of computers, capable of executing instructions, and moreover, although a logic sequence is shown in the flowchart, the shown or described steps may be executed in a sequence different from the sequence described here under some circumstances.

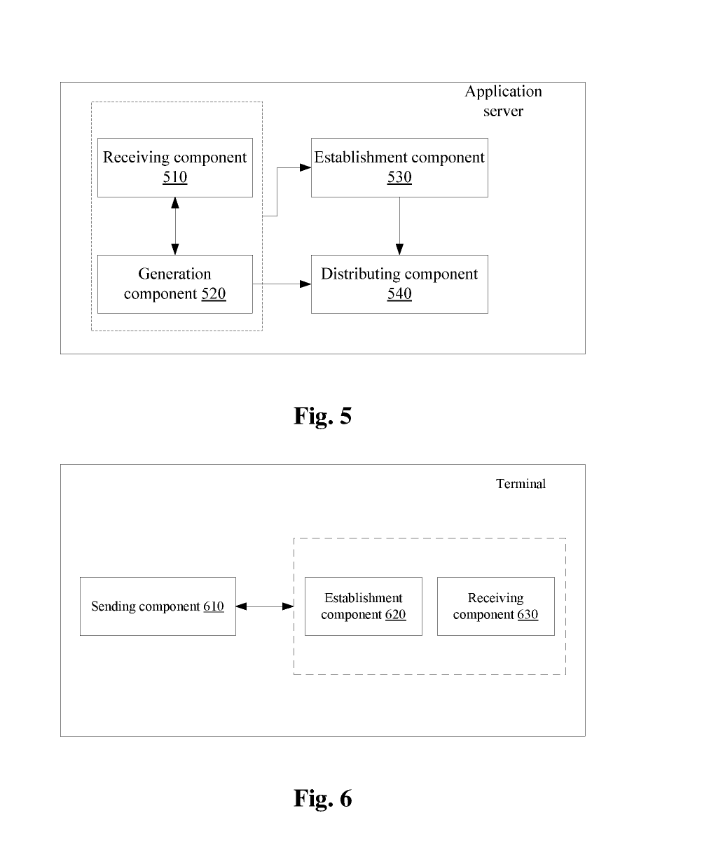

The embodiment of the present disclosure further provides a device for distributing content views, which may be configured to implement the abovementioned method. FIG. 5 is a first structure block diagram of a device for distributing content views according to an embodiment of the present disclosure, and as shown in FIG. 5, the device includes: a receiving component 510, configured to receive a content viewing session invitation request, wherein the content viewing session invitation request carries a spatial configuration of a content viewing session; a generation component 520, configured to generate a spatial distribution for requested content views among different content viewing session terminals according to the spatial configuration of the content viewing session; an establishment component 530, configured to establish content viewing sessions with the content viewing session terminals; and a distributing component 540, configured to distribute session contents to the corresponding content viewing session terminals according to the spatial distribution.

In an example embodiment, the device further includes: an acquisition component, configured to send a content views request to a content gateway to acquire the requested content views according to content views' identifiers carried in the content viewing session invitation request.

In an example embodiment, the generation component 520 is configured to check spatial attributes of the content views, and generate the spatial distribution based on spatial consistency between the spatial attributes of the content views and spatial attributes carried in the spatial configuration of the content viewing session.

In an example embodiment, the establishment component 530 is configured to determine, according to the spatial distribution, content viewing session terminals which receive the content views, and send a content viewing session invitation request to the determined content viewing session terminals to establish the content viewing sessions with the determined content viewing session terminals.

The device provided by the embodiment of the present disclosure may be deployed in an application server, and the corresponding components may be called for execution by a processor of the application server. A system environment of the application server is not limited in the embodiment of the present disclosure, and for example, an operating system such as Linux may be adopted.

The embodiment of the present disclosure further provides a device for receiving content views, which is located in a first terminal and may be configured to implement the abovementioned method for receiving content views. FIG. 6 is a first structure block diagram of a device for receiving content views according to an embodiment of the present disclosure, and as shown in FIG. 6, the device includes: a sending component 610, configured to send a content viewing session invitation request to an application server, wherein the content viewing session invitation request carries a spatial configuration of a content viewing session, wherein the spatial configuration of the content viewing session includes a spatial-attribute-based mapping between content views and content viewing session terminals; an establishment component 620, configured to establish a content viewing session between the first terminal and the application server; and a receiving component 630, configured to receive a first content view, which is distributed from the application server according to the spatial configuration of the content viewing session, corresponding to the first terminal.

The device in the embodiment of the present disclosure may be stored in a memory of the terminal, and the corresponding components are called for execution by a processor of the terminal. A system environment of the application server is not limited in the embodiment of the present disclosure.

It is important to note that the device described in the device embodiment corresponds to the method embodiment, and its specific implementation process has been described in the method embodiment in detail and will not be elaborated herein.

Scenario 2: Session-Mode-Based Session Content Configuration

In scenario 2 of the embodiment of the present disclosure, session contents may be distributed to corresponding content viewing session terminals according to a mode configuration of a content viewing session in a content viewing session invitation request, session mode attributes of requested session contents and session modes carried in the mode configuration of the content viewing session. A method for distributing session contents of the embodiment of the present disclosure will be described below in detail.

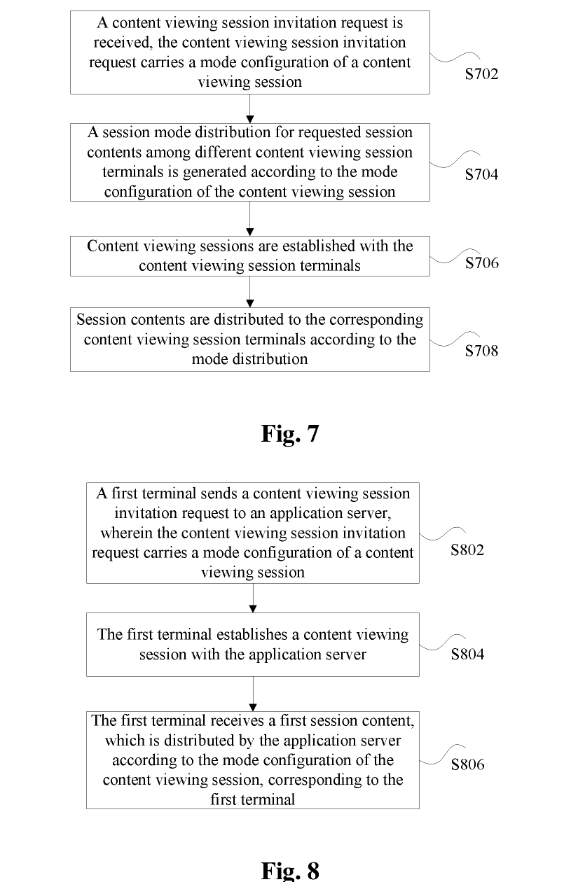

The embodiment of the present disclosure provides a method for distributing session contents, FIG. 7 is a second flowchart of a method for distributing session contents according to an embodiment of the present disclosure, and as shown in FIG. 7, the method includes the following steps (Step S702 to Step S708).

Step S702: a content viewing session invitation request is received, the content viewing session invitation request carrying a mode configuration of a content viewing session.

In this embodiment, the mode configuration of the content viewing session records session mode capabilities of multiple content viewing session terminals, i.e. session modes of session contents supported (or received) by each content viewing session terminal. In an example embodiment, the mode configuration of the content viewing session may include, but not limited to: a mode-based mapping between the content viewing session terminals and the session contents. The mode-based mapping records the session modes of the session contents supported (or received) by each content viewing session terminal. In the embodiment of the present disclosure, the session mode may include, but not limited to, at least one of: a video mode, a text mode, a voice mode and the like.

In an exemplary implementation mode of the embodiment of the present disclosure, the mode configuration of the content viewing session in the content viewing session invitation request may be an information list including identifiers of the content viewing session terminals, and the list records the session mode attributes of the session contents supported (or received) by each content viewing session terminal. For example, a session mode of content viewing session terminal 1 is “video mode”, and a session mode of content viewing session terminal 2 is “text mode”, namely terminal 1 may receive a video mode session content in requested session contents, and so on.

It is important to note that multiple forms may be adopted for carrying the mode configuration of the content viewing session in the content viewing session invitation request in consideration of different implementation protocols in a specific implementation process, and there are no limits made in the embodiment of the present disclosure.

In addition, a method for acquiring the session mode capabilities of each content viewing session terminal is not in the range of discussion of the embodiment of the present disclosure, and may be implemented by multiple methods according to the related technology. Therefore, the embodiment of the present disclosure makes descriptions only with an example. As an example of the embodiment of the present disclosure, configuration interfaces may be provided in the content viewing session terminals to configure a content viewing session terminal list, and the content viewing session terminals involved in the mode configuration of the content viewing session may be multiple content viewing session terminals of one user, and may also be, of course, content viewing session terminals of different users as long as their information is associated.

Step S704: a session mode distribution for requested session contents among different content viewing session terminals is generated according to the mode configuration of the content viewing session.

In the embodiment of the present disclosure, the session mode distribution for the session contents requested by the content viewing session invitation request among different content viewing session terminals may be generated according to the mode configuration of the content viewing session carried in the content viewing session invitation request, wherein the session mode distribution refers to a corresponding relationship between session modes of session contents and content viewing session terminals. In an example embodiment, when the session mode distribution is generated, session mode attributes of the session contents may be checked, and the mode distribution is generated based on mode consistency between the session mode attributes of the session contents and the session modes carried in the mode configuration of the content viewing session.

In an example embodiment, checking consistency may match the session mode attributes of the session contents and the session mode capabilities of the content viewing session terminals and associate the session contents and corresponding content viewing session terminals according to the session mode attributes of the session contents to obtain the mapping between the content viewing session terminals and the session contents.

For example, the mode configuration of the content viewing session includes a session mode capability “text mode” of content viewing session terminal 1 and a session mode capability “video mode” of content viewing session terminal 2, the session mode attributes of the requested session contents include “text mode”, “video mode” and “audio mode”, then the generated mode distribution indicates that content viewing session terminal 1 corresponds to the session content with the session mode attribute “text mode” and content viewing session terminal 2 corresponds to the session content with the session mode attribute “video mode”.

Of course, the example is only an exemplary description about the embodiment of the present disclosure, and in the embodiment of the present disclosure, the content viewing session terminals may also support multiple session mode attributes. For example, the content viewing session terminals may support the session contents with three session mode attributes “text mode”, “video mode” and “audio mode”, and mode distribution generation methods are substantially the same, and will not be elaborated in the embodiment of the present disclosure.

In the embodiment of the present disclosure, the session contents and their session mode attributes may be locally stored, and may also be stored in another server, so that a session content acquisition request may also be sent to a content gateway to acquire the requested session contents according to session contents' identifiers carried in the content viewing session invitation request if the session contents and their session mode attributes are not locally stored. After the session contents are acquired, the mode distribution is generated by the abovementioned method according to the session mode attributes of the session contents.

Step S706: content viewing sessions are established with the content viewing session terminals.

In the embodiment of the present disclosure, the sessions with the content viewing session terminals may be established according to the session mode attributes of the session contents and the session mode capabilities of the content viewing session terminals.

In an example embodiment, the sessions with each content viewing session terminal may be directly established under the condition that the session mode capabilities of the content viewing session terminals in the mode configuration of the content viewing session are completely matched with the session mode attributes of the requested session contents. As an example of the condition, the content viewing session terminal initiating the content viewing session invitation request may have known the session mode attributes of the requested session contents, and then the content viewing session terminals corresponding to the session contents and their session mode capabilities are contained in the content viewing session invitation request for sending.

For example, the content viewing session terminal knows that the requested session contents include three session mode attributes “text mode”, “video mode” and “audio mode” before initiating the content viewing session invitation request, and the mode configuration of the content viewing session may include the content viewing session terminals corresponding to the session contents.

In addition, under the condition that the session mode capabilities of the content viewing session terminals in the mode configuration of the content viewing session and the session mode attributes of the requested session contents are unmatched but intersected, terminals required to establish content viewing sessions may be determined according to the mode distribution at first, and then the sessions with the determined terminals may be established. As an example of the condition, the session mode attributes of the requested session contents may not be known when the request is initiated, and multiple content viewing session terminals and their session mode capabilities are sent.

Of course, when the session is established, the content viewing session terminals may be determined according to the generated mode distribution, and the content viewing session terminals required to establish the content viewing sessions may also be determined based on mode consistency between the session mode attributes of the mode configuration of the content viewing session and the session mode attributes of the session contents.

Step S708: session contents are distributed to the corresponding content viewing session terminals according to the mode distribution.

In the embodiment of the present disclosure, the mode distribution describes the content viewing session terminals corresponding to the session mode attributes of the session contents, and the session contents may be sent to the corresponding content viewing session terminals according to the mode distribution respectively. The corresponding session contents refer to session contents of which session mode attributes are consistent with the session mode capabilities of the content viewing session terminals in the session contents.

It is important to note that there are no limits to a sequence of the steps in the embodiment of the present disclosure although each step is marked in a numbering form in the embodiment of the present disclosure, and the execution sequence of the steps of the embodiment of the present disclosure may be regulated. For example, Step S704 and Step S706 may be exchanged.

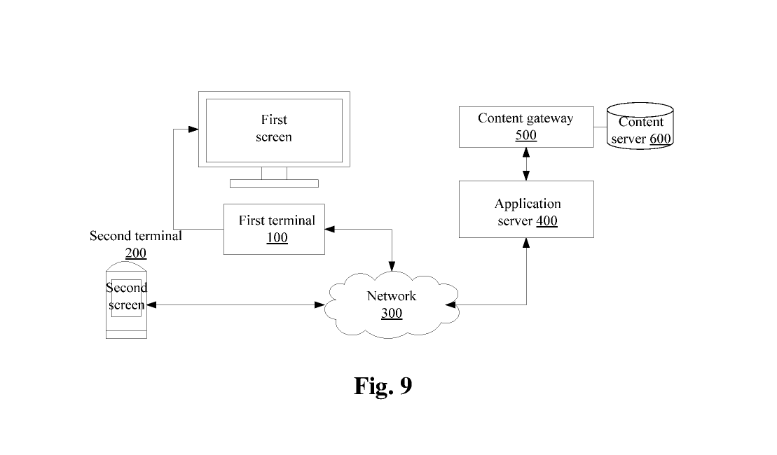

The embodiment of the present disclosure further provides a method for receiving session contents. FIG. 8 is a second flowchart of a method for receiving session contents according to an embodiment of the present disclosure, and as shown in FIG. 8, the method includes the following steps (S802-S806).

Step S802: a first terminal sends a content viewing session invitation request to an application server, wherein the content viewing session invitation request carries a mode configuration of a content viewing session, and the mode configuration of the content viewing session includes a mode-based mapping between session mode attributes of session contents and session mode capabilities of content viewing session terminals.

By Step S802, the mode configuration of the content viewing session may be sent to the application server, and then the application server may perform session content distributing according to the mode configuration of the content viewing session.

In the embodiment of the present disclosure, if there is no session content corresponding to the first terminal, a content viewing session between the first terminal and the application server may not be established, and subsequent steps are not required. It is important to note that a content viewing session invitation request sending method is also an independent solution of the embodiment of the present disclosure.

After the content viewing session invitation request is sent, Step S804 and Step S806 may also be executed. It is important to note that the content viewing session between the first terminal and the application server may also be established when there is no session content corresponding to the first terminal, and there are no limits made in the present disclosure.

Step S804: the first terminal establishes a content viewing session with the application server.

Step S806: the first terminal receives a first session content, which is distributed from the application server according to the mode configuration of the content viewing session, corresponding to the first terminal.

The method for receiving session contents of the embodiment of the present disclosure corresponds to the abovementioned method for distributing session contents, and the same or similar parts will not be elaborated in the embodiment of the present disclosure.

In an example embodiment, at least one second terminal in the content viewing session terminals receives a content viewing session request sent by the application server according to the mode configuration of the content viewing session, and establishes a content viewing session with the application server. The at least one second terminal receives a corresponding second session content sent by the application server according to the spatial configuration of the content viewing session.

In order to make the technical solutions and implementation methods of the present disclosure clearer, an implementation process will be described below with reference to an exemplary embodiment in detail.

In the exemplary embodiment of the present disclosure, the application server receives a content viewing session invitation request sent by a content viewing session terminal, and session contents are acquired according to a mode configuration of a content viewing session carried in the content viewing session invitation request, and are distributed to the content viewing session terminal. In the exemplary embodiment of the present disclosure, exemplary descriptions are made with a system shown in FIG. 9 as an example.

As shown in FIG. 9, the session system of the exemplary embodiment of the present disclosure at least includes a first terminal 100, a second terminal 200, a communication network 300, an application server 400, a content gateway 500 and a content server, wherein

the first terminal 100 and the second terminal 200 are responsible for sending content viewing session invitation requests according to session content selection of users to receive multimedia session contents such as an IPTV program and an OTT application, performing signal processing on the received contents for decoding and sending the processed contents to screens for playing. The first terminal 100 and the second terminal 200 may usually be mobile and fixed communication terminals such as intelligent mobile phones, tablets and set-top boxes. Moreover, the second terminal 200 is integrated with a second screen such as an intelligent mobile phone and a tablet in the embodiment of the present disclosure. Of course, there are no limits made in the present disclosure.

The first terminal 100 and the second terminal 200 are required to establish communication connections with the application server 400 on the basis of the communication network 300 to access service provided by a service provider and a content provider, and the communication connections are usually established through the communication network 300 such as a GSM, a UMTS, a WIMAX network, an LTE network and the like.

The application server 400 is responsible for providing a network side session service implementation capability, including: receiving and processing a content viewing session invitation request and content viewing session re-invitation request of a user terminal, establishing a session content distributing channel with the user terminal, implementing session state maintenance and lifecycle management, acquiring, storing and managing a session content and distributing the session content to the user terminal through the established session content distributing channel; and in addition, the application server 400 is further responsible for processing a registration request of the user terminal, and ensuring integrity and privacy of data and user privacy.

The content gateway 500 is responsible for providing a content access interface of the content server 600 for the application server 400, including: establishing a content session with the content server 600 to acquire requested session contents according to a request of the application server 400.

The content server 600 is responsible for providing a network side content storage capability, including: storing session contents and session contents' metadata.

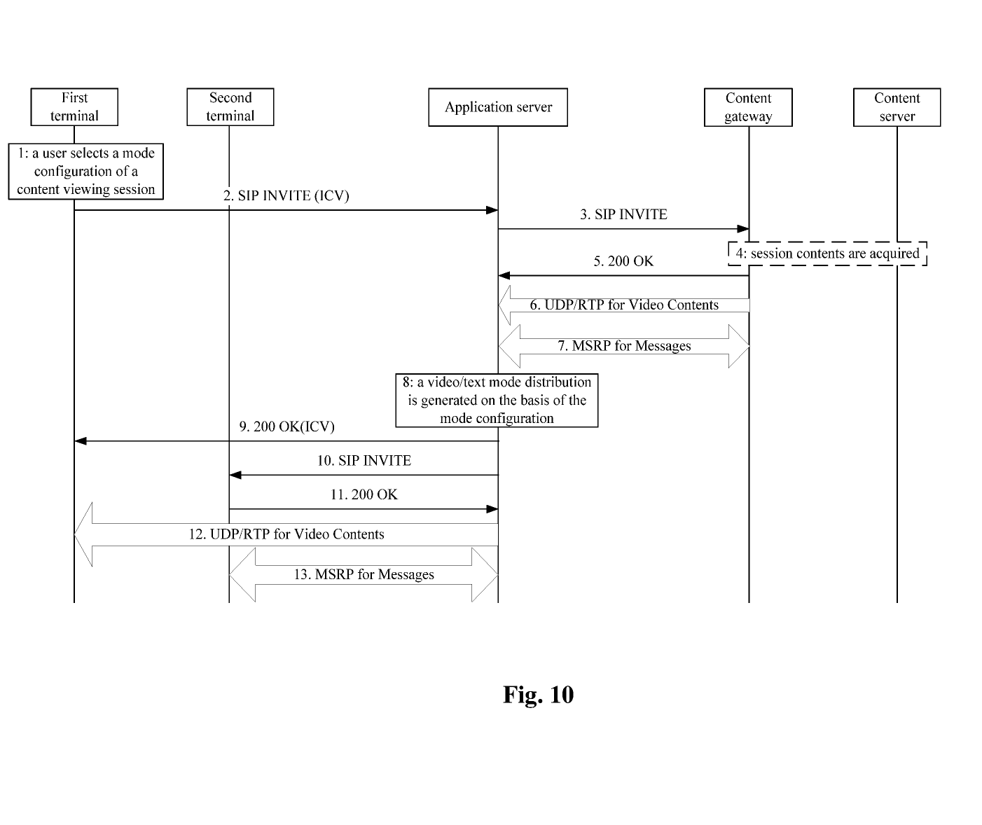

In the exemplary embodiment, a user has multiple content viewing session terminals, and by virtue of a first terminal, the user selects session contents and a mode configuration of a content viewing session, and sends a content viewing session invitation request. One or more other terminals, called second terminals, are involved in the mode configuration of the content viewing session. As shown in FIG. 10, a method of the embodiment includes the following steps (Step S1002 to Step S1044).

In the exemplary embodiment, the user has multiple content viewing session terminals, and by virtue of the first terminal, the user selects session contents and a mode configuration of a content viewing session, and sends a content viewing session invitation request. One or more other terminals, called second terminals, are involved in the mode configuration of the content viewing session.

The method of the embodiment includes Step S1002 to Step S1026, Step S1002 to Step S1026, as shown in FIG. 10, sequentially correspond to 1 to 11 in FIG. 10, and it is important to note that FIG. 10, serving as a diagram of interaction between equipment only, shows signalling interaction between the equipment. Each step of the embodiment of the present disclosure will be described below with reference to FIG. 10 in detail.

Step S1002 (corresponding to “1” in FIG. 10): the user browses selectable session contents on the first terminal, for example: an IPTV program (on demand or live), an Internet video clip and an OTT Internet multimedia application, which may be implemented by virtue of a content recommendation function or content searching function provided by a service provider in an existing service environment; and after session contents expected to be received are selected, the user may set the session contents, namely create session content configuration information.

In the embodiment, it is supposed that session contents simultaneously in a video playing mode and a text displaying mode are selected by the user. In order to better receive and process the session contents, the session content configuration information is a mode configuration of a content viewing session, namely the user may select a session mode configuration solution for session content receiving and playing of a content viewing session terminal, including, but not limited to: 1) a video session mode configuration, referring to that a specific content viewing session terminal may receive and play a video session content; 2) a voice session mode configuration, referring to that a specific content viewing session terminal may receive and play a voice session content; and 3) a text session mode configuration, referring to that a specific content viewing session terminal may receive and play a text session content.

In the exemplary embodiment, the mode configuration selected by the user is that a first session content (video content) is distributed to the first terminal and a second session content (text content) is distributed to a second terminal.

Step S1004 (corresponding to “2” in FIG. 10): the first terminal sends a content viewing session invitation request (SIP INVITE (ICV) message in FIG. 10) to the application server according to the choices of the user, wherein the request carries the session content configuration information which is the mode configuration of the content viewing session and used for setting a corresponding relationship between content viewing session terminals and session contents on the basis of session modes.

In the embodiment, the content viewing session invitation request is a SIP INVITE message, a header of the message carries session contents' identifiers, and the mode configuration of the content viewing session in a body of the message, as shown below, includes: a content viewing session terminal URI list and parameters of a mode configuration of a content viewing session.

```
    Content-Type: application/resource-lists+xml
    Content-Disposition: recipient-list
    <?xml version=“1.0” encoding=“UTF-8”?>
    <resource-lists xmlns=“urn:ietf:params:xml:ns:resource-lists”
    xmlns:isc=“urn:xxx:params:xml:ns:sessionControl”>
    <list>
    <entry uri= isc:modeConfiguration=“enabled” isc:mode=“video”/>
    <entry uri=sip:alice 2@example.com
    isc:modeConfiguration=“enabled”
isc:mode=“text”/>
    </list>
    </resource-lists>
```

In this embodiment, sip:alice 1@example.com and sip:alice 2@example.com represent a SIP URI of a first terminal of the user and a SIP URI of a second terminal respectively; isc:modeConfiguration=“enabled” represents that the session content configuration information is the mode configuration of the content viewing session; and isc:mode=“video” and isc:mode=“text” correspond to the session modes in the mode configuration, and represent that the first terminal is about to receive the first session content (video content) and the second terminal is about to receive the second session content (text content) respectively.

Step S1006 (corresponding to “3” in FIG. 10): the application server receives the content viewing session invitation request, and checks whether the corresponding session contents are locally cached or not according to the session contents' identifiers in the request, and if NO, the application server sends a session contents request (corresponding to SIP INVITE in FIG. 10) to the content gateway.

In the exemplary embodiment, the application server sends the session contents request through the SIP INVITE message. Without loss of generality, the application server may send the SIP INVITE message once to request the content gateway for all the session contents, and may also send the SIP INVITE message for many times to request the content gateway for all the session contents from different sources or for different parts (for example, video content and text content) of the session contents.

Step S1008 (corresponding to “4” in FIG. 10): the content gateway establishes a session with the content server to acquire the practical session contents. A method for establishing content viewing sessions and a practically adopted session content distributing technology are determined according to specific implementation of an external interface of the content server.

Step S1010 (corresponding to “5” in FIG. 10): the content gateway returns a 200 OK response to the application server, and establishes a session content distributing channel with the application server.

Step S1012˜Step S1014: the content gateway distributes the session contents to the application server. In the embodiment, the content gateway distributes the first session content (video content) to the application server through the established UDP/RTP media channel (corresponding to “6” in FIG. 10), and distributes the second session content (text content) to the application server through an established Message Session Relay Protocol (MSRP) media channel (corresponding to “7” in FIG. 10).

Step S1016 (corresponding to “8” in FIG. 10): the application server checks session modes of the acquired session contents, and generates a mode distribution for the session contents among different content viewing session terminals based on mode consistency between the session mode attributes of the session contents and the session modes carried in the spatial configuration of the content viewing session. In the embodiment, the mode distribution generated by the application server indicates that the first session content (video content) is distributed to the first terminal and the second session content (text content) is distributed to the second terminal.

Step S1018 (corresponding to “9” in FIG. 10): the application server acquires SIP URIs of all the content viewing session terminals. The application server returns a 200 OK response to the first terminal, and establishes a first session content (video content) distributing channel with the first terminal.

Step S1020˜Step S1022: the application server initiates a content viewing session invitation request to the second terminal (corresponding to “10” in FIG. 10) according to the SIP URI of the second terminal in the content viewing session terminal list, and establishes a second session content (text content) distributing channel with the second terminal (corresponding to “11” in FIG. 10).

Step S1024˜Step S1026: the application server distributes the first session content (video content) to the first terminal through the established UDP/RTP media channel (corresponding to “12” in FIG. 10), and distributes the second session content (text content) to the second terminal through the established MSRP media channel (corresponding to “13” in FIG. 10).

There exists another condition for Step S1020˜Step S1022, and the application server checks the session mode attributes of the acquired session contents, and judges whether there is the second session content (text content) corresponding to the second terminal in the acquired session contents or not according to the mode configuration of the content viewing session in the content viewing session invitation request. If YES, the application server sends a content viewing session request to the second terminal, and establishes the second session content (text content) distributing channel with the second terminal.

It is important to note that the steps shown in the flowchart of the drawing may be executed in a computer system, such as a group of computers, capable of executing instructions, and moreover, although a logic sequence is shown in the flowchart, the shown or described steps may be executed in a sequence different from the sequence described here under some circumstances.

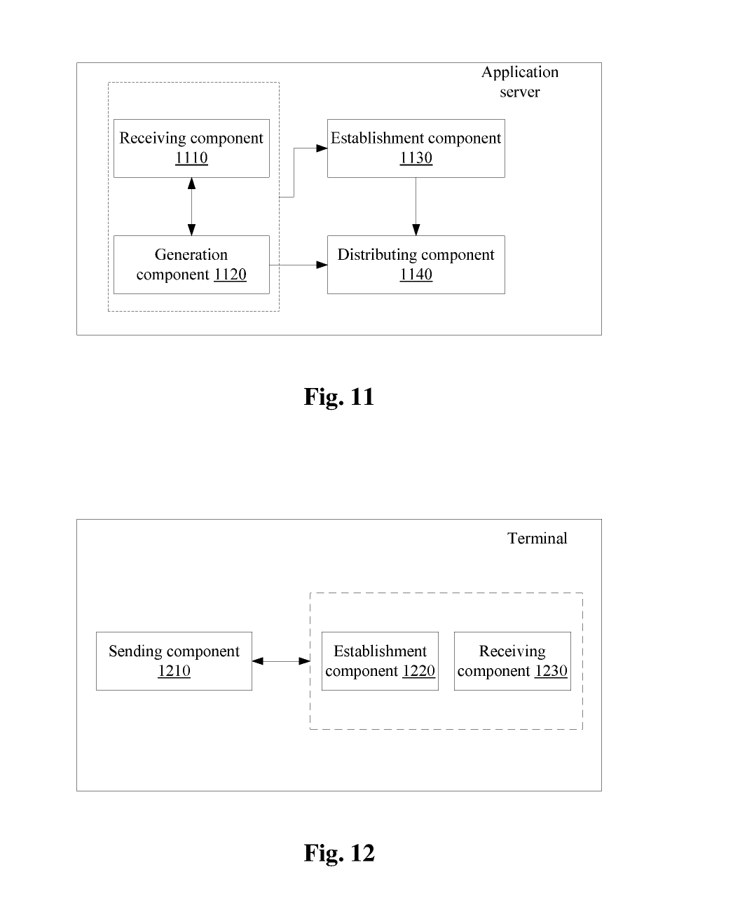

The embodiment of the present disclosure further provides a device for distributing session contents, which may be configured to implement the abovementioned method. FIG. 11 is a second structure block diagram of a device for distributing session contents according to an embodiment of the present disclosure, and as shown in FIG. 11, the device includes: a receiving component 1110, configured to receive a content viewing session invitation request, wherein the content viewing session invitation request carries a mode configuration of a content viewing session; a generation component 1120, configured to generate a mode distribution for requested session contents among different content viewing session terminals according to the mode configuration of the content viewing session; an establishment component 1130, configured to establish content viewing sessions with the content viewing session terminals; and a distributing component 1140, configured to distribute session contents to the corresponding content viewing session terminals according to the mode distribution.

In an example embodiment, the device further includes: an acquisition component, configured to send a session content acquisition request to a content gateway to acquire the requested session contents according to session contents' identifiers carried in the content viewing session invitation request.

In an example embodiment, the generation component 1120 is configured to check session mode attributes of the session contents, and generate the mode distribution based on mode consistency between the session mode attributes of the session contents and session modes carried in the mode configuration of the content viewing session.

In an example embodiment, the establishment component 1130 is configured to determine content viewing session terminals which receive the session contents according to the mode distribution, and establish the content viewing sessions with the determined content viewing session terminals.

The device provided by the embodiment of the present disclosure may be deployed in an application server, and the corresponding components may be called for execution by a processor of the application server. A system environment of the application server is not limited in the embodiment of the present disclosure, and for example, an operating system such as Linux may be adopted.

The embodiment of the present disclosure further provides a device for receiving session contents, which is located in a first terminal and may be configured to implement the abovementioned method for receiving session contents. FIG. 12 is a second structure block diagram of a device for receiving session contents according to an embodiment of the present disclosure, and as shown in FIG. 12, the device includes: a sending component 1210, configured to send a content viewing session invitation request to an application server, wherein the content viewing session invitation request carries a mode configuration of a content viewing session, wherein the mode configuration of the content viewing session includes a session mode-based mapping between session contents and content viewing session terminals; an establishment component 1220, configured to establish a content-viewing session between the first terminal and the application server; and a receiving component 1230, configured to receive a first session content, which is distributed from the application server according to the spatial configuration of the content viewing session, corresponding to the first terminal.

The device in the embodiment of the present disclosure may be stored in a memory of the terminal, and the corresponding components are called for execution by a processor of the terminal. A system environment of the application server is not limited in the embodiment of the present disclosure.

It is important to note that the device described in the device embodiment corresponds to the method embodiment, and its specific implementation process has been described in the method embodiment in detail and will not be elaborated herein.

From the above, according to the embodiment of the present disclosure, the content viewing session terminal carries the spatial configuration of the content viewing session (mode configuration of the content viewing session) in the content viewing session invitation request, and the application server generates the spatial distribution (mode distribution) of the content views (session contents) based on consistency between the spatial attributes (session mode attributes) of the content views (session contents) and the spatial attributes (session mode capabilities) in the spatial configuration (mode configuration), determines the content viewing session terminals corresponding to the content views (session contents), establishes the content viewing sessions with the corresponding content viewing session terminals and distributes the corresponding content views (session contents) respectively. Establishment of content viewing sessions and distributing of content views (session content) according to the characteristic of the session content are implemented.

Obviously, those skilled in the art should know that each component or step of the present disclosure may be implemented by a universal computing device, and the components or steps may be concentrated on a single computing device or distributed on a network formed by a plurality of computing devices, and may optionally be implemented by programmable codes executable for the computing devices, so that the components or steps may be stored in a storage device for execution with the computing devices, or may form each integrated circuit component respectively, or multiple components or steps therein can form a single integrated circuit component for implementation. As a consequence, the present disclosure is not limited to any specific hardware and software combination.

The above is only the exemplary embodiment of the present disclosure and not intended to limit the present disclosure. For those skilled in the art, the prevent disclosure may have various modifications and variations. Any modification, equivalent replacement, improvement and the like made within the principle of the present disclosure shall fall within the scope of protection defined by the appended claims of the present disclosure.

### INDUSTRIAL APPLICABILITY

The technical solutions provided by the embodiment of the present disclosure may be applied to the field of communication, and the spatial configuration of the content viewing session is contained in the content viewing session invitation request, so that the content views may be requested at least according to the spatial configuration, or the content views may be distributed at least according to the spatial configuration.

1. A method for distributing content views, comprising:
receiving a content viewing session invitation request, wherein the content viewing session invitation request carries a spatial configuration of a content viewing session;
generating a spatial distribution for requested content views among different content viewing session terminals according to the spatial configuration of the content viewing session; and
establishing content viewing sessions with the content viewing session terminals, and distributing content views to the corresponding content viewing session terminals according to the spatial distribution.

2. The method as claimed in claim 1, wherein the spatial configuration of the content viewing session comprises: a spatial-attribute-based mapping between content views and content viewing session terminals.

3. The method as claimed in claim 2, wherein a spatial attribute comprises at least one of:
a spatial relationship, comprising at least one of: top, bottom, left, right and middle;
a spatial location, comprising at least one of: east, west, south and north; and
a spatial orientation, comprising at least one of: facing east, facing west, facing south and facing north.

4. The method as claimed in claim 1, before generating the spatial distribution for the requested content views among different content viewing session terminals, further comprising:
sending a content views request to a content gateway to acquire the requested content views according to content views' identifiers carried in the content viewing session invitation request.

5. The method as claimed in claim 1, wherein generating the spatial distribution for the requested content views among different content viewing session terminals according to the spatial configuration of the content viewing session comprises:
checking spatial attributes of the content views, and
generating the spatial distribution based on spatial consistency between spatial attributes of content views and spatial attributes carried in the spatial configuration of the content viewing session.

6. The method as claimed in claim 1, wherein establishing the content viewing sessions with the content viewing session terminals comprises:
determining, according to the spatial distribution, content viewing session terminals which receive the content views; and
sending a content viewing session invitation request to the determined content viewing session terminals to establish the content viewing sessions with the determined content viewing session terminals.

7. A method for establishing content viewing sessions, comprising:
sending, by a first terminal, a content viewing session invitation request to an application server, wherein the content viewing session invitation request carries a spatial configuration of a content viewing session, and the spatial configuration comprises a spatial-attribute-based mapping between content views and content viewing session terminals.

8. The method as claimed in claim 7, wherein a spatial attribute comprises at least one of:
a spatial relationship, comprising at least one of: top, bottom, left, right and middle;
a spatial location, comprising at least one of: east, west, south and north; and
a spatial orientation, comprising at least one of: facing east, facing west, facing south and facing north.

9. The method as claimed in claim 7, further comprising:
establishing, by the first terminal, a content viewing session with the application server; and
receiving, by the first terminal, a first content view, which is distributed from the application server according to the spatial configuration of the content viewing session, corresponding to the first terminal.

10. The method as claimed in claim 7, further comprising:
receiving, by at least one second terminal in the content viewing session terminals, a content viewing session request sent by the application server according to the spatial configuration of the content viewing session, and establishing a content viewing session with the application server; and
receiving, by the at least one second terminal, a second content view, which is distributed from the application server according to the spatial configuration of the content viewing session, corresponding to the at least one second terminal.

11. A device for distributing content views, located in an application server and comprising:
a receiving component, configured to receive a content viewing session invitation request, wherein the content viewing session invitation request carries a spatial configuration of a content viewing session;
a generation component, configured to generate a spatial distribution for requested content views among different content viewing session terminals according to the spatial configuration of the content viewing session;
an establishment component, configured to establish content viewing sessions with the content viewing session terminals; and
a distributing component, configured to distribute content views to the corresponding content viewing session terminals according to the spatial distribution.

12. The device as claimed in claim 11, wherein the spatial configuration of the content viewing session comprises: a spatial-attribute-based mapping between content views and content viewing session terminals.

13. The device as claimed in claim 12, wherein a spatial attribute comprises at least one of:
a spatial relationship, comprising at least one of: top, bottom, left, right and middle;
a spatial location, comprising at least one of: east, west, south and north; and
a spatial orientation, comprising at least one of: facing east, facing west, facing south and facing north.

14. The device as claimed in claim 11, further comprising:
an acquisition component, configured to send a content views request to a content gateway to acquire the requested content views according to content views' identifiers carried in the content viewing session invitation request.

15. The device as claimed in claim 11, wherein the generation component is configured to check spatial attributes of the content views, and generate the spatial distribution based on spatial consistency between the spatial attributes of the content views and spatial attributes carried in the spatial configuration of the content viewing session.

16. The device as claimed in claim 11, wherein the establishment component is configured to determine, according to the spatial distribution, content viewing session terminals which receive the content views, and send a content viewing session invitation request to the determined content viewing session terminals to establish the content viewing sessions with the determined content viewing session terminals.

17. A device for establishing content viewing sessions, located in a first terminal and comprising:
a sending component, configured to send a content viewing session invitation request to an application server, wherein the content viewing session invitation request carries a spatial configuration of a content viewing session, and the spatial configuration of the content viewing session comprises a spatial-attribute-based mapping between content views and content viewing session terminals.

18. The device as claimed in claim 17, wherein a spatial attribute comprises at least one of:
a spatial relationship, comprising at least one of: top, bottom, left, right and middle;
a spatial location, comprising at least one of: east, west, south and north; and
a spatial orientation, comprising at least one of: facing east, facing west, facing south and facing north.

19. The device as claimed in claim 17, further comprising:
an establishment component, configured to establish a content viewing session with the application server; and
a receiving component, configured to receive a first content view, which is distributed from the application server according to the spatial configuration of the content viewing session, corresponding to the first terminal.

20. An application server, comprising: a processor and a storage medium, the processor being configured to execute an instruction for executing the method as claimed in claim 1 stored in the storage medium.

21. A terminal, comprising: a processor and a storage medium, the processor being configured to execute an instruction for executing the method as claimed in claim 7 stored in the storage medium.
